(19) United States
(12) Patent Application Publication
(10) Pub. No.: US 2012/0254759 A1
(43) Pub. Date: Oct. 4, 2012

(54) BROWSER-BASED RECORDING OF CONTENT

(76) Inventors: David S. Greenberg, Boston, MA (US); Li Li, Redmond, WA (US); Radhika S. Jandhyala, Redmond, WA (US); Sathyanarayanan Karivaradaswamy, Sammamish, WA (US); Mehmet Kucukgoz, Seattle, WA (US)

(21) Appl. No.: 13/077,791

(22) Filed: Mar. 31, 2011

(51) Int. Cl. G06F 3/01; G06F 15/16

(52) U.S. Cl. 715/719; 715/716

(57) ABSTRACT

This document describes techniques for browser-based recording and streaming of content. In at least some embodiments, a web browser interfaces with recording devices (e.g., a video camera, a microphone, a still-image camera, and so on) of a computing device to stream content data from live events and to record the live events to produce content files. The web browser can also upload the content files to a web-based resource, such as a web server. Further to some embodiments, the techniques can enable multiple recording devices to be used concurrently to record live events. Also in at least some embodiments, the techniques can enable concurrent or semi-concurrent recording and upload of content. For example, a portion of a live event can be recorded and the resulting content data can be uploaded while additional portions of the live event are recorded.

### BACKGROUND

In today's online environment, users often want to record and view live events and generate content from the recorded live events, such as video content, audio content, pictures, and so on. Enabling users to view streaming data from live events, record the live events, and manage the resulting content, however, can present challenges for application developers in a web-based environment. For example, in the context of web browser applications, a web browser typically must call an external utility to record live events for the web browser. This can slow the recording process and increase the complexity of the application development process since a developer typically has to design the web browser to interface with the external utility.

In addition, many current computing devices include multiple recording devices, such as multiple video cameras. Recording utilities, however, typically only enable one instance of a particular type of recording device to be used at a time. For example, a computing device with two video cameras often cannot record video concurrently with both video cameras.

A further challenge to content management in an online environment exists in the upload of content to a web resource. For example, a user that wants to record a live event and upload the resulting content to a web resource typically must first record the live event via a local device and then upload the resulting content to the web resource. This increases the time required to complete the recording and upload process which in turn ties up computing resources that can be used for other tasks.

### SUMMARY

This document describes techniques for browser-based recording of content. In at least some embodiments, a web browser is configured to interface with recording devices (e.g., a video camera, a microphone, a still-image camera, and so on) of a computing device to record live events and produce content files from the live events. Examples of content files include a video file, an audio file, an image file, and so on. The web browser can also upload the content files to a web-based resource, such as a web server.

In at least some embodiments, live events can be captured using multiple recording devices to produce one or more content files and to enable access to streaming content data. For example, a computing device can include multiple recording devices, such as multiple video cameras, multiple microphones, and so on. According to some embodiments, the techniques can enable one or more of the recording devices to be selected for capturing live events and, in some embodiments, can enable multiple recording devices to be used concurrently to record one or more live events.

Also in at least some embodiments, the techniques can enable concurrent or semi-concurrent recording of live events and upload of content data produced from the recording of the live events. For example, a first portion of a live event can be captured to produce a first portion of content data. While the first portion of content data is being uploaded, a second portion of the live event can be recorded to produce a second portion of content data. Thus, in at least some embodiments, a recording process and a content data upload process can run concurrently or semi-concurrently. This can enable content to be captured and uploaded in an efficient manner.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit of a reference number identifies the figure in which the reference number first appears. The use of the same reference number in different instances in the description and the figures may indicate similar or identical items.

FIG. 1 is an illustration of an environment for browser-based recording of content.

FIG. 2 is a flow diagram depicting an example process for browser-based recording of one or more live events in accordance with one or more embodiments.

FIG. 3 is a flow diagram depicting an example process for enabling a live event to be concurrently recorded and streamed as video data in accordance with one or more embodiments.

FIG. 4 is a flow diagram depicting an example process for utilizing a plurality of recording devices to record one or more live events in accordance with one or more embodiments.

FIG. 5 is a flow diagram depicting an example process for concurrent or semi-concurrent recording and upload of content in accordance with one or more embodiments.

### DETAILED DESCRIPTION

Example Environment

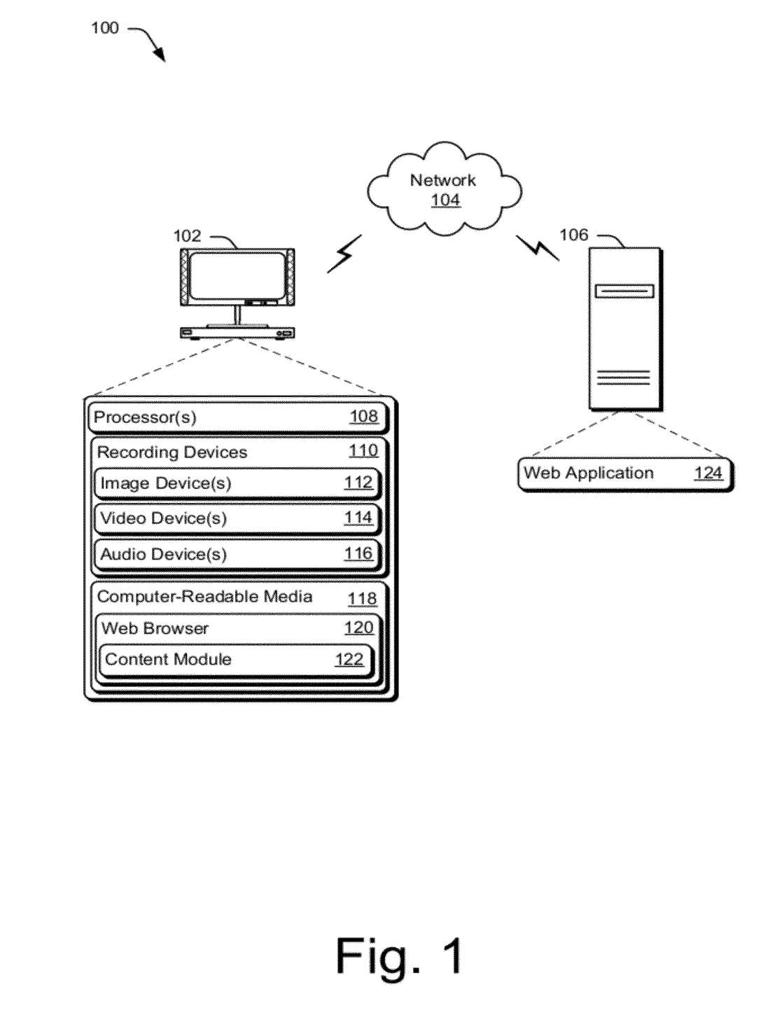

FIG. 1 is an illustration of an environment 100 in which techniques for browser-based recording of content can operate. Environment 100 includes a computing device 102, a network 104, and a network resource 106. Computing device 102 is shown as a desktop computer for purposes of example only, and computing device 102 may be embodied as a variety of different types of devices. Network resource 106 can include a variety of different devices and entities to which content can be uploaded, such as a web server, a local server (e.g., a LAN server), a cloud computing resource, a website, and so on.

As also illustrated in FIG. 1, computing device 102 includes processor(s) 108 and recording devices 110. The recording devices 110 include image device(s) 112, video device(s) 114, and audio device(s) 116. The image device(s) 112 can include a camera and/or other device that is configured to record still images and the video device(s) 114 can include a video camera and/or other device that is configured to record video images. The audio device(s) 116 can include a microphone and/or other device that is configured to record audio.

The computing device 102 further includes computer-readable media 118, which includes or has access to a web browser 120. The web browser 120 includes a content module 122 that is configured to implement various techniques discussed herein for browser-based recording of content. In at least some embodiments, the content module 122 is configured to interface with the recording devices 110 to enable various types of live events to be recorded and converted to digital content.

Further illustrated in FIG. 1 is a web application 124 that is included as part of the network resource 106. The web application 124 can include a variety of different types of applications and/or utilities that can send content to and/or receive content from the computing device 102. In at least some embodiments, content can be uploaded from the computing device 102 to the network resource 106 and published via the web application 124 for access by other devices (not illustrated) that are connected to the network 104.

Note that one or more of the entities shown in FIG. 1 may be further divided, combined, and so on. Generally, any of the functions described herein can be implemented using software, firmware, hardware (e.g., fixed-logic circuitry), manual processing, or a combination of these implementations. The terms “application”, “module”, and “browser”, as used herein generally represent software, firmware, hardware, whole devices or networks, or a combination thereof In the case of a software implementation, for instance, these terms may represent program code (e.g., computer-executable instructions) that performs specified tasks when executed on a processor (e.g., CPU or CPUs). The program code can be stored in one or more computer-readable memory devices, such as computer-readable media 118. As utilized herein, computer-readable media can include all forms of volatile and non-volatile memory and/or storage media that are typically associated with a computing device. Such media can include ROM, RAM, flash memory, hard disk, removable media, and the like.

Example Processes for Browser-Based Recording of Content

The following discussion describes example processes for browser-based recording of content. Aspects of these processes may be implemented in hardware, firmware, software, or a combination thereof These processes are shown as sets of blocks that specify operations performed, such as through one or more entities of FIG. 1, and are not necessarily limited to the order shown for performing the operations by the respective blocks. In portions of the following discussion reference may be made to environment 100 of FIG. 1, though these are not necessarily required.

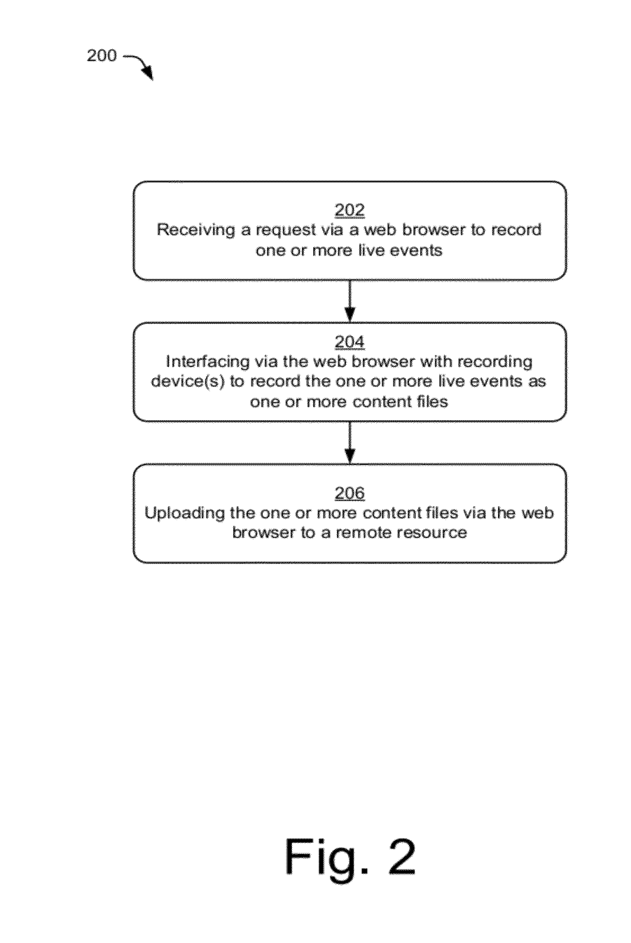

FIG. 2 is a flow diagram depicting an example process 200 for browser-based recording of one or more live events. In at least some embodiments, a live event refers to a physical event that occurs in real time and that generates recordable phenomena, such as light waves, sound waves, and so on. Block 202 receives a request via a web browser to record one or more live events. For example, a user can provide input to a web browser user interface that indicates that the user wants to record a live event and/or the request can be generated by an external resource (e.g., an application such as the web application 124) and sent to the web browser.

Block 204 interfaces via the web browser with one or more recording devices to record one or more live events as one or more content files. In at least some implementations, the web browser can include an application programming interface (API) (e.g., as part of the content module 122) that can communicate with a recording device to initialize and coordinate the recording of live events. In at least some embodiments, the API can enable the web browser to communicate directly with a recording device (e.g., via a device driver) without requiring a user to interact with an external application or other utility. The recorded live event can then be stored as one or more content files on a computing device local to the web browser. In at least some embodiments, one or more content files can include multiple content files that can be stored separately or merged into a single content file.

Block 206 uploads the one or more content files via the web browser to a remote resource. For example and with reference to FIG. 1, the content module 122 can upload the content file(s) to the web application 124. In at least some embodiments, the web application 124 can enable multiple different users to access to the content file(s) via the network 104. In the context of video content, the web application 124 can be part of a video sharing website that can enable captured and uploaded video content to be accessed by many different users.

In an example implementation where the content file(s) include an image file, a uniform resource identifier (URI) can be generated for the image file (e.g., by the content module 122) and used to reference the image file. The URI can be used to set a source for an image tag (e.g., a hypertext markup language (HTML) <img> tag) and/or can be uploaded to a remote resource such as the web application 124. The remote resource can then use the URI to retrieve the image file.

In a further example implementation, where the content file(s) include a video file, a uniform resource locator (URL) can be generated for the video file (e.g., by the content module 122) and used to reference the video file. In at least some embodiments, the URL can be used as a source attribute for a video tag (e.g., an HTML <video> tag) and can be used to cause the video file to be played based on the video tag.

According to at least some embodiments and in the context of recording video content, a number of invocable methods can affect the video recording process. For example, invoking a stop method (e.g., StoppableOperation.stop( )) can cause video content that is being recorded to be finalized and returned in response to a success callback. Additionally, invoking a cancel method (e.g., StoppableOperation.cancel( )) can cause video content that is being recorded to be discarded and can further cause a fail callback to be invoked. In at least some embodiments, if it is determined that a video content file is too large (e.g., during the recording process), all or part of the video content file can be discarded and a notification that the video recording process has stopped and/or failed can be sent.

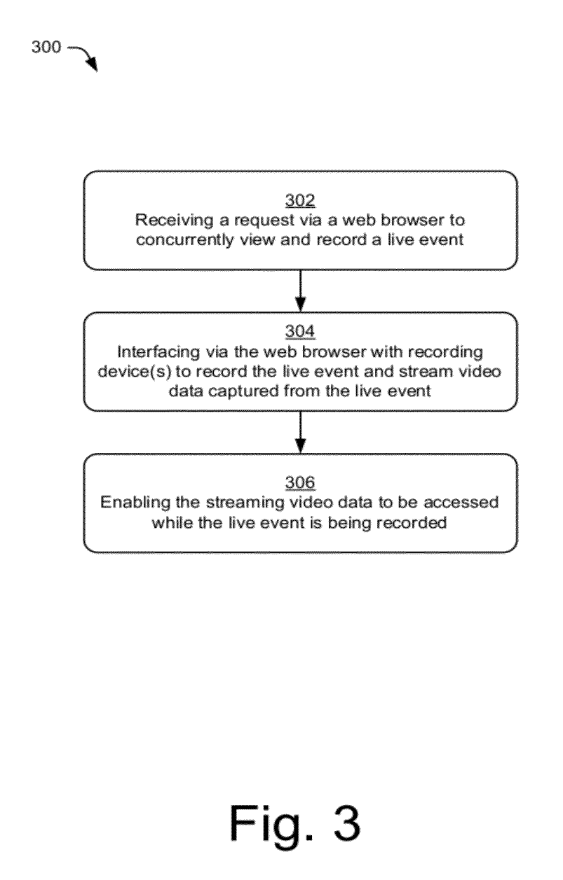

FIG. 3 is a flow diagram depicting an example process 300 for enabling a live event to be concurrently recorded and streamed as video data. Block 302 receives a request via a web browser to concurrently view and record a live event. For example, a user can provide input to a web browser user interface that indicates that the user wants to concurrently record and view a live event and/or the request can be generated by an external resource (e.g., an application such as the web application 124) and sent to the web browser.

Block 304 interfaces via the web browser with one or more recording devices to record the live event and to stream video data captured from the live event. For example, the web browser can communicate with one or more drivers for the recording devices to record the live event and to access a video data stream from the recording devices. Block 306 enables the streaming video data to be accessed while the live event is being recorded. In at least some embodiments, the web browser can generate tags (e.g., URLs) for the streaming video data and/or the recorded video data that enable each to be accessed.

Further to certain implementations, the web browser can enable a video data stream to by toggled on and off by a user and/or a remote resource, such as the web application 124. Thus, implementations enable a video stream of a live event to be turned off while the live event is being recorded without affecting the recording process. Additionally, implementations enable a process of recording a live event to be turned off without affecting access to streaming video data from the live event. Thus, streaming video data and recorded video data from a single recording device and/or multiple recording devices can be independently accessed and controlled.

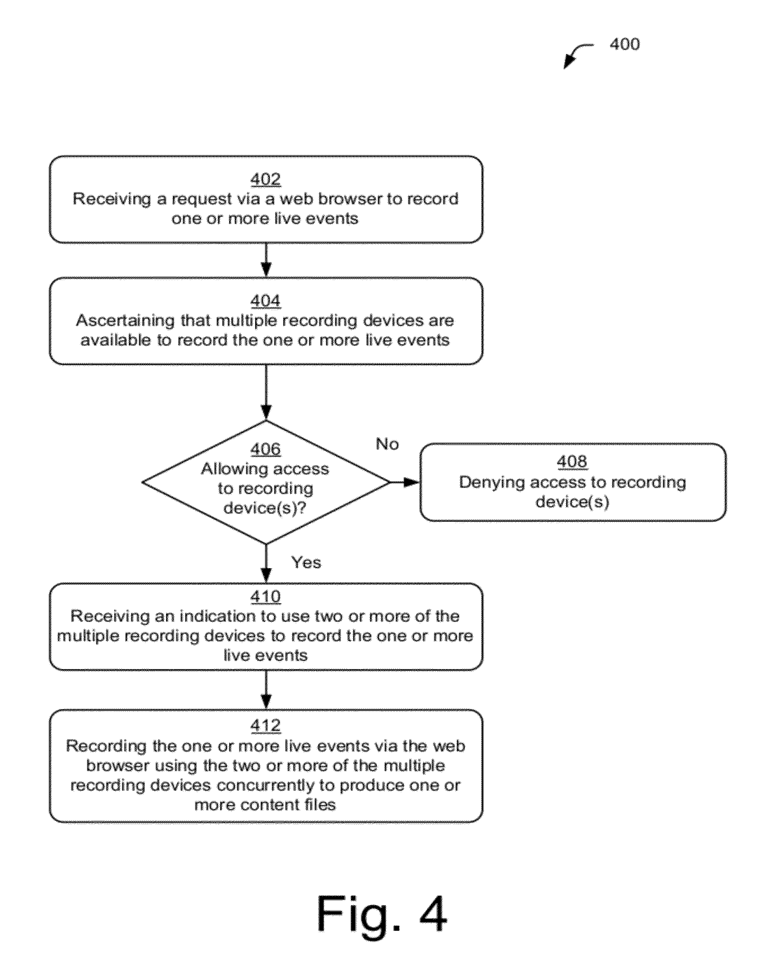

FIG. 4 is a flow diagram depicting an example process 400 for utilizing a plurality of recording devices to record one or more live events. Block 402 receives a request via a web browser to record one or more live events. For example, the request can be received responsive to user input and/or responsive to a communication from an external resource, e.g., the web application 124. Block 404 ascertains that multiple recording devices are available to record the one or more live events. In at least some embodiments, a single computing device can include the multiple recording devices. Although not expressly illustrated here, a user interface can be displayed that enables a user to select which of the multiple recording devices to use to record the live event(s).

Block 406 determines whether or not to allow access to one or more of the multiple recording devices. In at least some embodiments, a remote resource such as the web application 124 can request access to one or more of the multiple recording devices. Responsive to this request, a user can be given the option (e.g., via a user interface) to allow or deny the access. In accordance with at least some implementations, a user can allow or deny access on a device-by-device basis. For example, if the remote resource is requesting access to multiple recording devices, the user can allow or deny access to each of the multiple recording devices individually. Thus, a user may allow access to a first device yet deny access to another. This can enable a user to be aware of recording events and to have more control over the user's own privacy. If access to the one or more of the multiple recording devices is not allowed (“No”), block 408 denies access to the one or more of the recording devices.

If access to the one or more of the multiple recording devices is allowed (“Yes”), block 410 receives an indication to use two or more of the multiple recording devices to record the one or more live events. For example, the indication can be received responsive to user selection of the two or more of the multiple recording devices via a user interface. As mentioned above, a single computing device can include the multiple recording devices. Thus, in at least some embodiments, the two or more of the multiple recording devices can include devices that are configured to record a single type of content, e.g., two or more video cameras, two or more microphones, two or more still-image cameras, and so on.

Block 412 records the one or more live events via the web browser using the two or more of the multiple recording devices concurrently to produce one or more content files. In at least some embodiments, the two or more of the multiple recording devices can record the one or more live events simultaneously. For example, envision a scenario where the two or more of the multiple recording devices are two video cameras and a single computing device includes the two video cameras. According to at least some embodiments, techniques discusses herein enable the two video cameras on the single computing device to be operated simultaneously to record video content. This scenario is not intended to be limiting, however, and the two or more of the multiple recording devices can include devices that are configured to record a variety of different content, such as audio content, still images, and so on.

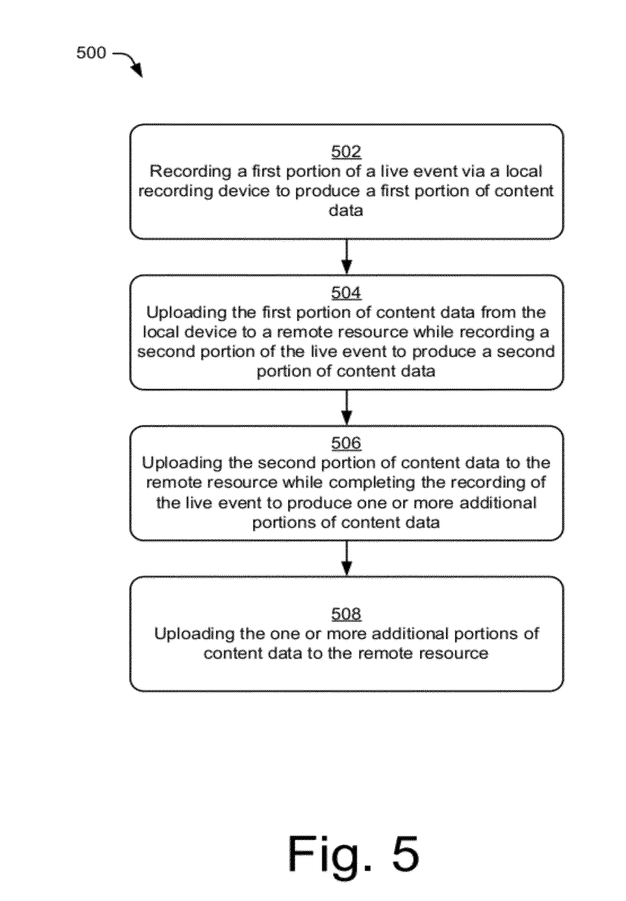

FIG. 5 is a flow diagram depicting an example process 500 for concurrent or semi-concurrent recording and upload of content. Block 502 records a first portion of a live event via a local recording device to produce a first portion of content data. For example, the live event can be recorded via one or more of the recording devices 110. Block 504 uploads the first portion of content data from the local device to a remote resource while recording a second portion of the live event to produce a second portion of content data.

In at least some embodiments, the process 500 can upload the content data (e.g., the first portion and/or the second portion of content data) to the remote resource according to time-based and/or byte-based intervals. For example, in the context of a time-based interval, the process can automatically upload content data from the local device to the network resource according to a predetermined time interval, e.g., every 10 milliseconds. Thus, as the live event is recorded, portions of the content data that have not already been uploaded can be uploaded to the remote resource according to the time interval, e.g., at each expiration of the time interval.

In the context of a byte-based interval, when a particular portion of the content data is produced (e.g., 1 kilobyte), the process can automatically upload the particular portion of content data to the remote resource. Thus, in at least some embodiments, content data associated with the recorded live event can be uploaded to the remote resource according to a byte-wise basis.

Further, a progress callback function can be used to upload the content data to the remote resource. For example, the progress callback function can be called when a time interval has expired and/or a certain amount of content data (e.g., in bytes) has been produced. In at least some embodiments, the time interval can be user-specified, such as via the content module 122. Responsive to the progress callback function being called (e.g., by a local device and/or a remote resource), a portion of the content data can be uploaded from the local device to the remote resource.

Returning to the example process 500, block 506 uploads the second portion of the content data to the remote resource while the completing the recording of the live event to produce one or more additional portions of content data. The second portion of the content data can be uploaded in a time-based and/or byte-based manner, examples of which are discussed above. Block 508 uploads the one or more additional portions of the content data to the remote resource. The one or more additional portions of the content data can be uploaded in a time-based and/or byte-based manner, examples of which are discussed above.

Real-time Content Streaming

In at least some embodiments, techniques discussed herein can be used to stream real-time content, such as live video and/or audio. For example, content that is captured via one or more of the recording devices 110 can be streamed for consumption as it is being captured. To enable real-time content to be streamed, techniques herein can represent a real-time content stream via a URL. For example, the content module 122 can generate a URL that can be used to access a real-time content stream that is generated by one or more of the recording devices 110. In at least some embodiments, the URL can be used in a video tag (e.g., an HTML video tag) that can enable the real-time content stream to be accessed when the video tag is accessed.

Further to some embodiments, recorded content (e.g., video content, audio content, still images, and so on) and real-time content can be configured for simultaneous or semi-simultaneous consumption. For example, a webpage associated with the network resource 106 can include markup (e.g., HTML) that includes tags that link to recorded content and real-time content. When the webpage is accessed (e.g., via the web browser 120), the recorded content can be played back and the real-time content can be streamed simultaneously or semi-simultaneously. By enabling recorded content and real-time content to be represented via tags and/or URLs, both types of content can be easily embedded in documents (e.g., webpages) and accessed for consumption.

Consistent API

In at least some embodiments, techniques discussed herein can be implemented using one or more consistent application programming interfaces (APIs). For example, an API can enable access to content discussed herein via the recognition of calling conventions, tag names, function names, and/or method names that are consistent across multiple different applications and/or requesting entities. With reference to the real-time content streaming discussed above, a consistent API can enable access to a real-time content and recorded content via a tag (e.g., a video tag) such that both types of content can be accessed in a similar manner. Thus, a developer or other entity can use the same type of tag to access multiple types of content via the consistent API. With reference to the environment 100 discussed above, the consistent API can be embodied as one or more portions of the content module 122.

Attributes Parameter

In some cases, attribute parameters can be provided that enable recording attributes for the recording of live events to be controlled. Examples of recording attributes include bit rate, sample rate, frame rate, exposure, brightness, zoom, contrast, and so on. Thus, a web browser user interface can be configured to enable a user to control the recording attributes via input to the user interface. A user that wants a faster content upload, for example, can specify a lower content resolution (e.g., video resolution and/or image resolution) such that the content can be uploaded faster. Alternatively, the user can specify a higher content resolution that will, in some embodiments, increase the time required to upload the content.

Conclusion

This document describes techniques for browser-based recording of content. In some embodiments, these techniques enable a web browser to interface with recording devices to record live events as content without requiring an external utility or application. Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A computer-implemented method comprising:
receiving a request via a web browser to record one or more live events;
interfacing via the web browser with one or more recording devices to record the one or more live events as one or more content files independent of a user interaction with an application that is external to the web browser; and
uploading the one or more content files via the web browser to a remote resource.

2. The method as recited in claim 1, wherein the interfacing via the web browser with the one or more recording devices comprises enabling a video data stream captured from the one or more live events to be streamed in real-time while the one or more live events are being recorded.

3. The method as recited in claim 2, wherein the interfacing via the web browser with the one or more recording devices to record the one or more live events is implemented via a recording process, and wherein the method further comprises enabling the video data stream and the recording process to be toggled on and off individually.

4. The method as recited in claim 2, wherein the interfacing comprises interfacing with the one or more recording devices via an application programming interface (API) of the web browser, and wherein the API is configured recognize a consistent calling convention to enable access to the video data stream and the one or more content files.

5. The method as recited in claim 1, wherein the one or more recording devices comprise multiple recording devices, and wherein the interfacing comprises interfacing via the web browser with the multiple recording devices to record the one or more live events simultaneously.

6. The method as recited in claim 1, further comprising generating a uniform resource identifier (URI) for the one or more content files and wherein the uploading comprises uploading the one or more content files to the remote resource responsive to a content request that includes the URI.

7. The method as recited in claim 1, further comprising:
generating a first URL for the one or more content files;
generating a second URL that enables access to real-time content generated by the one or more recording devices; and
enabling the one or more content files and the real-time content to be accessed simultaneously or semi-simultaneously via the first URL and the second URL.

8. The method as recited in claim 7, wherein enabling the one or more content files and the real-time content to be accessed simultaneously or semi-simultaneously via the first URL and the second URL is performed via a consistent application programming interface (API).

9. A computer-implemented method comprising:
receiving a request via a web browser to record one or more live events;
ascertaining that multiple recording devices are available to record the one or more live events;
receiving an indication to use two or more of the multiple recording devices to record the one or more live events; and
recording, via the web browser, the one or more live events using the two or more of the multiple recording devices concurrently to produce one or more content files.

10. The method as recited in claim 9, wherein receiving the request comprises receiving the request at the web browser from a remote resource, the request comprising an access request from the remote resource requesting access to one or more of the multiple recording devices.

11. The method as recited in claim 9, wherein receiving the indication to use the two or more of the multiple recording devices is responsive to:
determining whether or not to allow access to the two or more of the multiple recording devices; and
allowing access to the two or more of the multiple recording devices responsive to a user input that indicates that the access is allowed.

12. The method as recited in claim 9, wherein receiving the indication to use the two or more of the multiple recording devices comprises receiving a user selection of the two or more of the multiple recording devices via the web browser.

13. The method as recited in claim 9, wherein receiving the indication to use the two or more of the multiple recording devices comprises receiving user input via the web browser to set one or more recording attributes, and wherein recording the one or more live events via the web browser comprises recording the one or more live events according to the one or more recording attributes.

14. The method as recited in claim 9, wherein the two or more of the multiple recording devices comprise video recording devices associated with a single computing device and wherein the one or more content files comprise video content.

15. The method as recited in claim 9, further comprising:
associating a first tag with the one or more content files;
configuring a second tag to enable access to real-time content generated by one or more of the multiple recording devices; and
enabling the one or more content files and the real-time content to be accessed simultaneously or semi-simultaneously via the first tag and the second tag.

16. A computer-implemented method comprising:
recording a first portion of a live event via a local recording device to produce a first portion of content data;
uploading the first portion of content data from the local device to a remote resource while recording a second portion of the live event to produce a second portion of content data; and
uploading the second portion of content data to the remote resource while completing the recording of the live event.

17. The method as recited in claim 16, wherein the first portion of content data comprises a specific number of bytes of content data and wherein uploading the first portion of content data from the local device to the remote resource is responsive to an indication that the specific number of bytes of content data has been produced.

18. The method as recited in claim 16, wherein uploading the first portion of content data from the local device to the remote resource is responsive to an indication of an expiration of a predetermined time interval.

19. The method as recited in claim 16, wherein uploading the first portion of content data from the local device to the remote resource is responsive to a callback function that is called responsive to the first portion of the live event being recorded.

20. The method as recited in claim 16, wherein uploading the first portion of content data from the local device to the remote resource is responsive to a callback function that is called responsive to an expiration of a predetermined time interval.
